(19) United States
(12) Patent Application Publication
(10) Pub. No.: US 2024/0078579 A1
(43) Pub. Date: Mar. 7, 2024

(54) SYSTEM AND METHOD FOR APPLYING A RANKED SEQUENCE IDENTIFICATION TO A LIMITED-EDITION ITEM

(71) Applicant: Timothy James Ryan, Chicago, IL (US)

(72) Inventor: Timothy James Ryan, Chicago, IL (US)

(21) Appl. No.: 18/230,400

(22) Filed: Aug. 4, 2023

Related U.S. Application Data
(60) Provisional application No. 63/374,571, filed on Sep. 5, 2022.

(51) Int. Cl. G06Q 30/0282; G06Q 30/0601

(52) U.S. Cl. CPC G06Q 30/0282; G06Q 30/0635

(57) ABSTRACT

A system and method for ordering, ranking, producing, marking, and shipping limited run or limited availability/edition items, such as clothing items, is provided. A web-based or other ordering system is used to process an order. Upon payment, a sequential and ranked Sequence ID is generated for the purchased item. This Sequence ID expresses an ordered ranking within the item's ordering and/or production timeline. The unique, ranked Sequence ID may be applied to a patch or otherwise printed directly onto the limited-edition item and included as a prominent feature for visual appeal or other benefit. A certificate of authenticity may be generated with the limited-edition, ranked item.

### CROSS-REFERENCE TO RELATED APPLICATIONS

The present disclosure claims priority to U.S. Prov. Pat. App. No. 63/374,571, titled “A System and Method for applying a ranked sequence ID to a clothing item” filed Sep. 5, 2022, which is incorporated herein by reference in its entirety.

### TECHNICAL FIELD

The present disclosure relates generally to a system and method of receiving and processing orders for limited-edition items. More specifically, the present disclosure relates to a system and method for generating and applying a Sequence Identification (Sequence ID), which provides a numerical or other identifying indicia indicating production ranking to identify when an item was produced in a production sequence. The Sequence ID is associated with or physically affixed onto the item.

### BACKGROUND

Clothing and related personal style accessories, and the combination of these items, is one of the primary ways many people express themselves. Some of these clothing and personal style accessories are produced in vast quantities while others are produced with a limited supply, limited-edition or are even one-of-a-kind items. Generally, there is no visual tagging system to show how limited a product is or the ordered rank position the item holds in the production sequence.

Many products currently in the marketplace are coupled with unique identification tags. Some examples include VIN numbers, serial numbers, and bar codes, just to name a few. Clothing items and personal style accessories may also have unique identification generated for them that are affixed to the product. For example, some designer items, such as purses and belts, may have a unique serial number which identifies the item as authentic. However, there are no prior instances of an identification system that includes an identifier for the ordered rank of an item in the production sequence and based on purchase timeline incorporated into a clothing item or style accessory as an attribute of the item.

Therefore, a need exists for a system and method that incorporates a sequence identification marking on a limited-edition item. The present disclosure provides a system and method for processing product orders and associating the product with a unique marking (Sequence ID) that identifies the ordered position in the sequence or position in production of the particular product associated with the Sequence ID. Additionally, the present system and method incorporates a control such that the same Sequence ID cannot be used for more than one product. The control also provides a time limit allocated to a customer for completing a purchase, before the order is voided. The control provides an incentive for completion of a purchase and ensures that customers cannot simply maintain an indefinite hold on an item without purchase, thus preventing the next customer from purchasing an item and receiving a Sequence ID.

Use and assignment of a ranked Sequence ID on a limited-edition item offers greater value to the consumer, whether for esthetic purposes, or for knowing how widely produced a given item or style might be. In some instances, the Sequence ID may enable limited-edition clothing items to be valued in a secondary marketplace and potentially valued as collectible items. There are numerous applications where a rank-based Sequence ID applied to a clothing item, or other limited-edition items would be of use.

### SUMMARY

The present disclosure relates to a system and method for ordering, ranking, producing, marking, and shipping limited availability or limited-edition items, such as clothing items. The items are marked with a ranked sequence identification (herein referred to as “Sequence ID”), which may be physically applied to the clothing item. An online shopping platform or optionally, a non-computer-based ordering system is used to process an order from a customer. Upon payment, a sequential and ranked Sequence ID is generated for the item. This Sequence ID expresses an ordered rank within the item's ordering timeline. Additionally, the Sequence ID may be used to identify the sequence order in production for a particular item.

For example, the first clothing item ordered within a given run is number 1, the second item ordered in that same run is number 2, and so-on. Each run will have a fixed number of total units produced. The ranked Sequence ID is applied to a patch or otherwise printed onto the clothing item and included as a prominent feature of the clothing item, for visual appeal or other benefit. The number of units in a specific run may also be added to the patch or to any suitable graphical/physical method is used to mark the clothing item. The system may then generate a certificate of authenticity and/or ownership for the item that identifies the garment, the Sequence ID, the number of units in the run, and the registered owner's (Buyer's) name. Additional data may be added to the certificate, including date of production, artist name, title of work on garment etc. The certificate of ownership may be shipped with the clothing item.

To this end, an embodiment of the present disclosure provides a method for ordering and ranking limited-edition items. The method includes the steps of providing a user interface on a computer system; offering a listing of limited-edition items available on the user interface for purchase, processing a purchase order of a specific limited-edition item, wherein the computer system generates a sequence identification based on a time and date of the purchase order of the limited-edition item; and, wherein the sequence identification provides a rank to the specific limited-edition item in an overall sequence of production limited-edition items.

In another embodiment of the present disclosure, a system and method for generating and applying a ranked sequence identification to a limited-edition item, is provided. The system comprises a computer system having a user interface configured for selection of a limited-edition item, a product selection module configured to receive and process a purchase order for the limited-edition item, wherein the product selection module generates a ranked sequence identification for the purchased item, a production process module configured for associating the sequence identification with the purchased item and producing a transferable certificate of authenticity matched to the sequence identification.

It is, therefore, an advantage and objective of the present disclosure to provide a system and method for ordering and ranking limited-edition items, wherein the system and method generate a unique sequence identification which is assigned to a specific limited-edition item after purchase. The system and method of the present disclosure further include a control for limiting the time available to the consumer for purchase of a particular item, and also for controlling assignment of the sequence identification to ensure no two products have the same sequence identification.

Additional features and advantages of the present disclosure are described in, and will be apparent from, the detailed description of the embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a flowchart for a system and method of receiving and processing orders for limited-edition items, including a computer network that includes client computers coupled to a server computer, along with modules for generating and affixing the ranked Sequence ID, according to the present disclosure.

FIG. 2 illustrates user interface web browser for ordering a limited-edition item and also verifying the next available ranked sequence ID, according to the present disclosure.

FIG. 3 illustrates a flowchart detailing the steps of processing an order, beginning at the product selection process, and continuing to the point of where the ranked sequence ID is affixed to the limited-edition item.

FIG. 4 illustrates a limited-edition item having a graphic applied and a sequence ID ranking applied to the item.

### DETAILED DESCRIPTION

The present disclosure relates a system and method for processing orders for and identifying limited production and limited-edition items in a product ordering system. Specifically, the present system and method generate a ranked sequence identification (Sequence ID), which provides an associated order ranking of an item's position within the total production sequence of units. The Sequence ID may also include the purchase order number in a series of items, which may include a limited-edition or limited production run of an item. The system and method may be useful for identifying limited edition and collectable items, including unique clothing and/or clothing items having unique embellishments or artwork. The Sequence ID may be associated with a printed certificate included with the item, and/or may be physically affixed as a tag to the clothing item. The Sequence ID can be numerical, such as a serial number, bar code, graphic, design, symbol, or any form of indicia or distinguishing mark that may useful for uniquely identifying the production sequence of the particular item.

System Hardware and Component Overview

The system and method for processing orders for and identifying limited production and limited-edition items in a product ordering system of the present disclosure utilizes a server-based computer (or computer system), hosted onsite or offsite, which transmits and receives data over a standard phone line, cable line, or a computer network. The steps of accessing, recording, downloading, and processing the data, as well as other aspects of the present disclosure are implemented by a central processing unit (CPU) in the server computer executing sequences of instructions stored in a memory. The memory may be a random-access memory (RAM), read-only memory (ROM), a persistent store, such as a mass storage device, or any combination of these devices. Execution of the sequences of instructions causes the CPU to perform steps according to embodiments of the present disclosure.

The data and software instructions may be imputed into the memory of the server computer from a storage module, or from one or more other computer systems connected over a network. For example, a customer's computer may transmit a sequence of instructions to the central ordering computer in response to a message transmitted. As the central ordering computer receives the instructions, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU and may instead be executed by an interpreter that interprets the instructions. In other embodiments, hardwired circuitry may be used in place of, or in combination with, software.

Product Selection and Ordering System

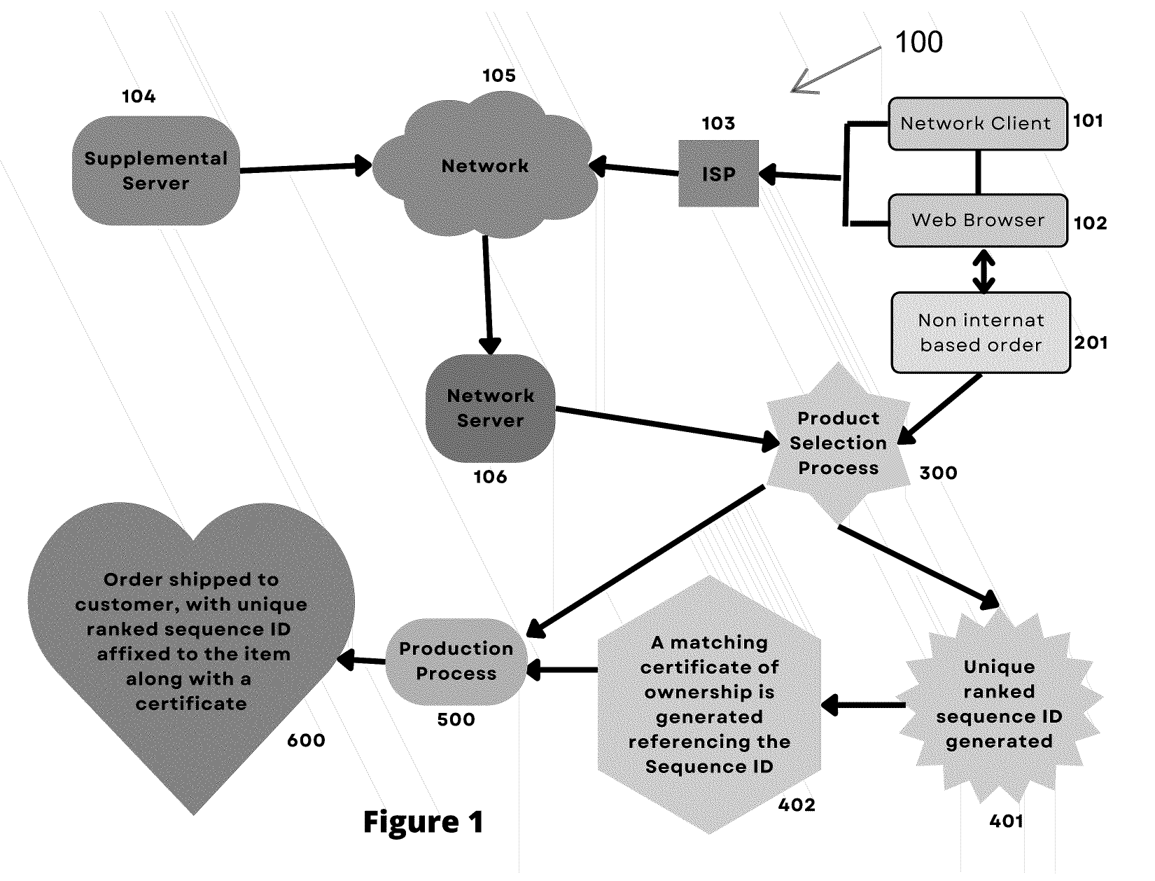

Referring now to the figures, FIG. 1 illustrates a flowchart for the product selection and ordering system 100 of the present disclosure. The product selection and ordering system 100 includes various software and hardware components, which together provide real time data on remaining inventory or a given item and the next available Sequence ID. The product selection/ordering process module 300 is accessed by the customer 101 by connecting through a web browser 102 and ISP 103 to the network 105 and network server 106 of the website. Alternatively, a customer without internet access may simply call the contact number of the product website to place an order 201.

The hardware components of the product selection and ordering process module 300 may reside on different servers and/or client computers in a distributed or networked computer system. Various embodiments of the present disclosure may be on-line implementations that utilize the Internet network and various Internet-specific technologies. However, it should be noted that alternative embodiments of the present disclosure may utilize other types of network technologies. For example, the networks coupling the product selection process module to the generation of the Sequence ID 401 and attaching this Sequence ID to the item 600 before shipment, be implemented as any type of computer network, such as a private LAN (local area network), WAN (wide area network), intranet, extranet, wireless network or any combination thereof that connects two or more computers together.

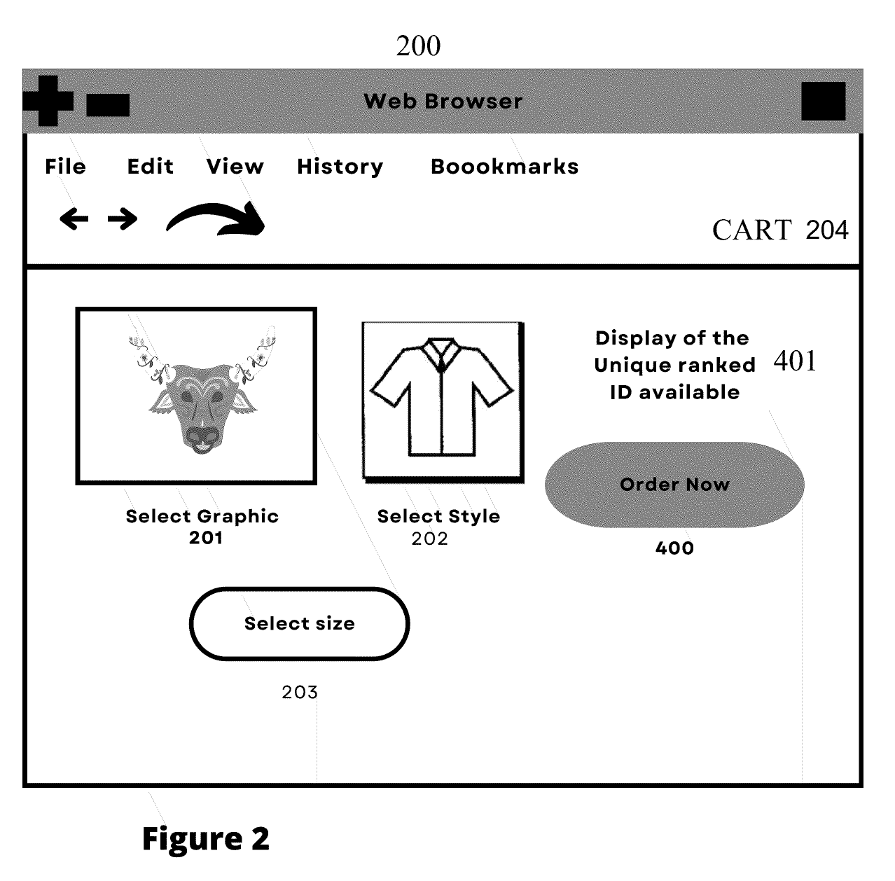

FIG. 2 illustrates an embodiment of the present disclosure in which the network utilized in the product selection and ordering system is a web browser 200 on the Internet. The product selection and ordering process module 300 is typically implemented through user interface programs that utilize web server and web browser programs. Alternatively, however, these processes can be implemented as proprietary or dedicated software programs that communicate over a public or private computer network that couples the on-line ordering platform to the users.

FIG. 2 illustrates an example of a web browser window 200, which the customer sees displayed on the screen of the customer's computer 102 during the ordering/purchasing process. During the purchasing process, by clicking on the appropriate icons, the customer selects a specific unique graphic 201, a particular style of clothing 202 and clothing size 203 and adds the information to a cart 204. The clothing item 202 may be displayed as a digital rendering, or in actual form either displayed alone, on a model, or in a similar type of representation. Various views or representations of the item may be displayed.

After the customer orders a clothing item 202, the product selection and ordering process module 300 transmits the product specification data from the product selection website to a production process module 500, as illustrated in FIG. 1. The production process module 500 determines and affixes the proper ranked Sequence ID 401 to the corresponding clothing item prior to the order being packed and shipped to the customer 600.

Specifically, upon selection of an item 202 by a customer, the production process module 500 receives the order information through the product selection and ordering process module 300, together with the Sequence ID 401 generated and assigned to the particular item. A matching certificate of ownership 402 having the unique Sequence ID 401 is also assigned to the purchased item. The clothing item 202 is then packed and delivered to a carrier for shipment and delivery 600 to the customer.

The production process module 500 keeps track of all of the necessary production steps, including processing payment for the item 202 or product, assigning the ranked Sequence ID 401 to the purchased item 202, and managing the user's account, up to shipment and delivery 600 of the purchased item to the customer with the associated Sequence ID associated with the item.

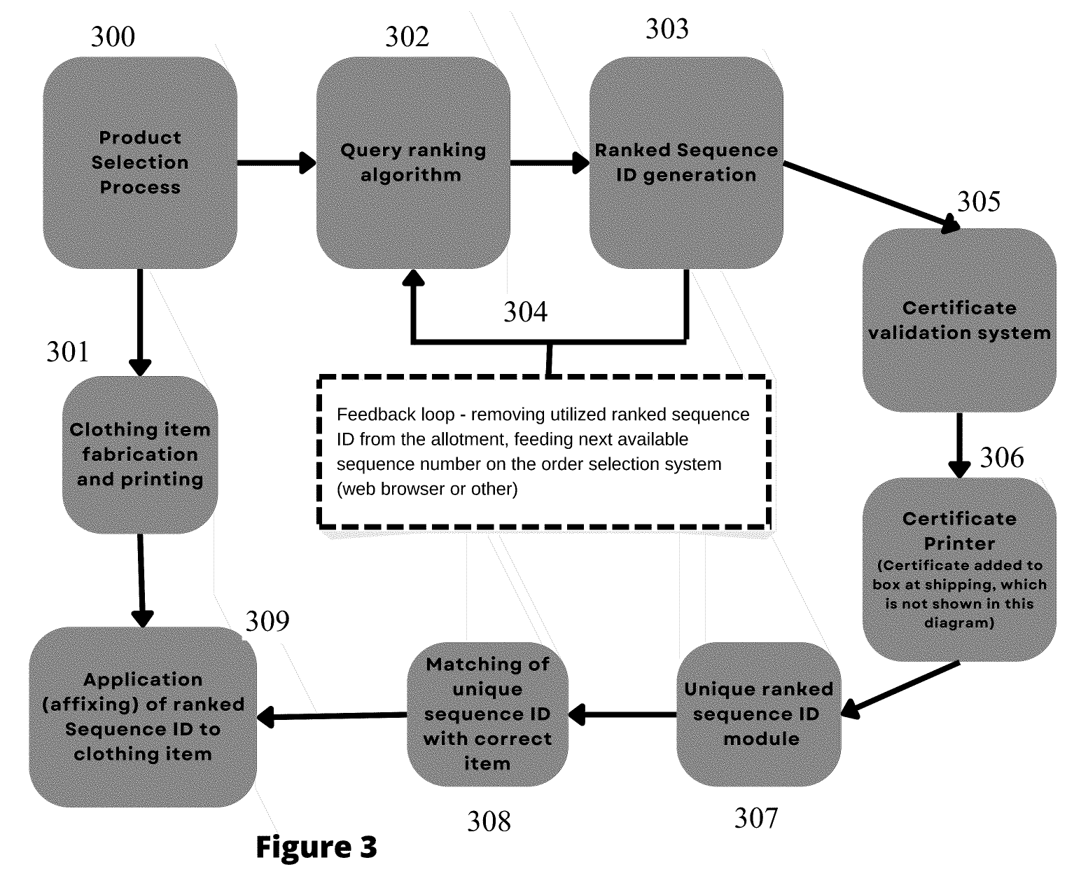

FIG. 3 illustrates a flowchart detailing the algorithm used in the product selection and ordering process module 300 of the present disclosure. Initially, the product selection and ordering process module 300 is initiated with selection of a clothing or other item 301, which may include the step of selection, fabrication and printing of the particular clothing item. The product selection and ordering process module 300 further includes a query ranking algorithm 302, which generates the ranked Sequence ID 401 for the particular order in process step 303. Generation of the Sequence ID 401 is supported by a feedback loop 304, wherein previously used Sequence IDs are removed from the allotment and the next available Sequence ID number is provided in the selection process. In this manner, a unique Sequence ID 401 is generated for each specific single order, and therefore no two Sequence IDs are the same.

In an alternative embodiment, the ranked Sequence ID 401 is available to be associated with a purchase for a fixed or limited time for the customer to complete the purchase. If the purchase is not completed within the fixed time period, the ranked Sequence ID 401 may be made available again for another purchase. Utilizing a fixed time for purchase implements a control within the product selection process because a customer cannot indefinitely “hold” an item in his/her cart, thereby preventing purchase of the product by another customer. This control step further ensures that the assigned Sequence ID 401 is unique and not repeated for a specific purchase. Additionally, the control means that purchase of items is not held up by an indecisive customer. A unique Sequence ID assigned to one specific item may provide collectable value to limited-edition items.

Most products offered under the present ordering and ranking system and method may be available for only a limited time, and/or be offered in a limited supply. Additionally, some customers may be considering a purchase based solely on the ranked Sequence ID 401 available on the next available item, whether considering an item early in the production run or later in the production run. For this situation, the control may be in the form of an order clock embedded within an “Order Now” box 400 displayed during the purchase (FIG. 2). Once the customer specifies all the information regarding the product, the user can proceed to finalize the product order by selecting “checkout” or “Order Now” or similar command. As the order clock runs, it encourages competition of the sale, and assignment of the Sequence ID 401. Additionally, if the time period for purchase runs out and the customer has not completed the order, the “Order Now” box may disappear, and the customer can no longer purchase the item or hold up the purchase of the item by another customer in the queue.

After generation of the Sequence ID 401, the next step in the product selection and ordering process module 300 is generation of a certificate of validation 304 and a printed certificate of authenticity 305. The printed certificate of authenticity 305 includes relevant information concerning the purchased item as well as the Sequence ID 401 generated for that unique item. As illustrated, the certificate of authenticity 305 is typically printed and included with the item for shipment to the customer.

The next step in the product selection and ordering process module 300 is the creation of account data associated with the Sequence ID 401. The account information associated with a particular user/customer may include personal data, for example, a customer's past purchases, Sequence IDs 401 associated with those purchases, sales of items on an auction site, etc., essentially any information associated with the customer and his/her purchases. This data may be included with the Sequence ID 401 of the current item being purchased, along with specific meta data on the order sequence. This data is compiled together, and a physical tag is created though Ranked Sequence ID step 307, which matches the ordered item 308. Physical tags displaying a particular ranked Sequence ID 401 may be shipped to a location hosting the production process 500 (FIG. 1) for application onto the corresponding clothing item as illustrated at step 309 (FIG. 3).

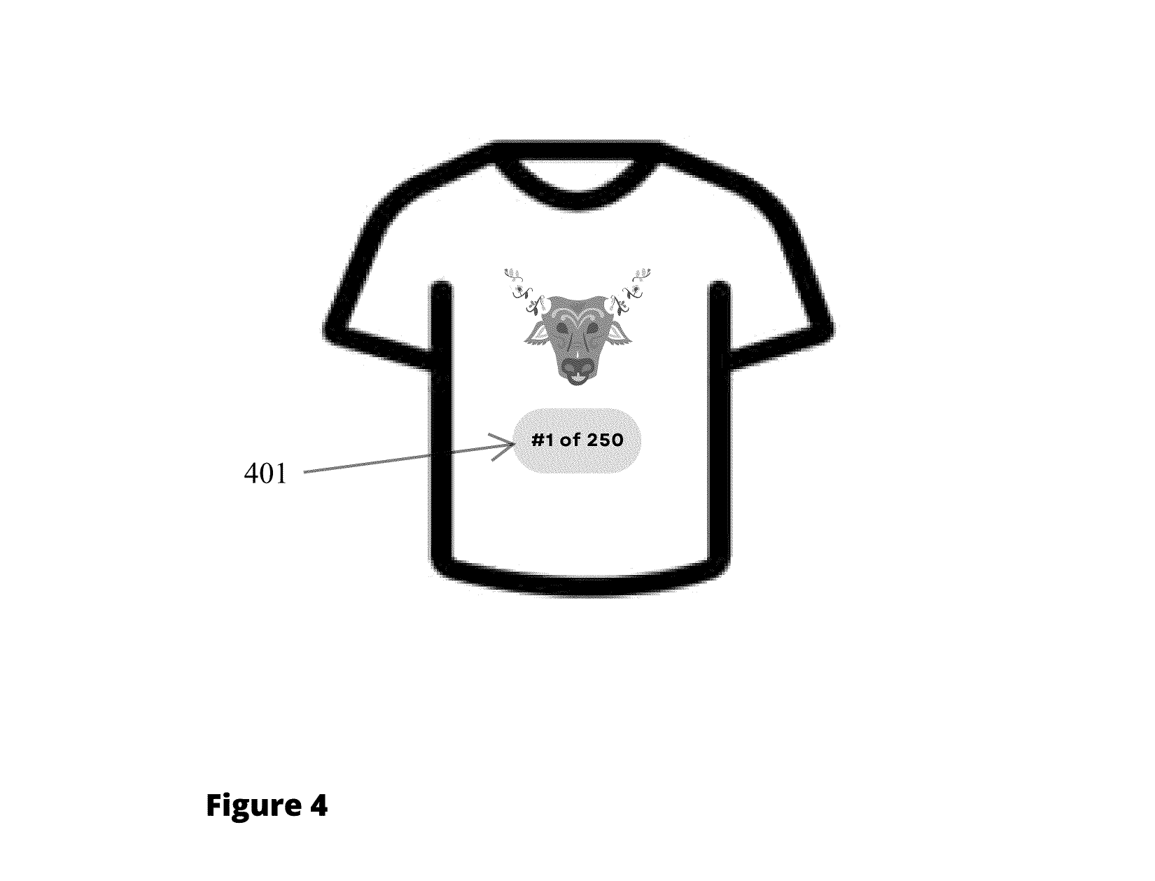

Alternatively, the ranked Sequence ID 401 is applied to a physical tag shipped to the customer either separately, or with the purchased clothing item, so that the customer can affix the Sequence ID tag to the clothing item him/herself after receiving the particular item. An example of how the ranked sequence ID 401 may appear on a clothing item is shown on FIG. 4.

In the foregoing, a system and method has been provided for producing and ordering custom products and allocating a ranked Sequence ID 401 for use in identifying and recognizing limited-edition clothing items. Although embodiments of the present disclosure were described and illustrated with reference to clothing items, it should be understood that the present system and method could be directed to other types of products having limited supply or production. Such products may include limited-edition or short-run products that are customizable to a certain degree, i.e., through application of unique artwork, and require some degree of production processing prior to delivery to the user. For example, other apparel products could include footwear, such as shoes, tennis shoes/sneakers, boots, and sandals; sports apparel, or fashion accessories, such as handbags, scarfs, and so on. Many of these items have value as collectables, and having an assigned sequence ID ranking may add to the value of these items to the collector.

Although the present disclosure has been described with reference to specific exemplary embodiments, it will be evident that various modifications and changes may be made to these embodiments without departing from the broader spirit and scope of the disclosure as set forth in the claims. Accordingly, the specification and drawings are to be regarded in an illustrative rather than a restrictive sense.

I claim:

1. A method for ordering and ranking limited-edition items, the method comprising the steps of:
providing a user interface on a computer system;
offering a listing of limited-edition items available on the user interface for purchase;
processing a purchase order of a specific limited-edition item;
wherein the computer system generates a sequence identification based on a time and date of the purchase order of the limited-edition item; and,
wherein the sequence identification provides a rank to the specific limited-edition item in an overall sequence of production limited-edition items.

2. The method of claim 1, wherein the method further includes a step of restricting a subsequent purchase of a limited-edition item in sequence until completion of a prior purchase of a limited-edition item.

3. The method of claim 1, wherein an initial purchase of a limited-edition item is completed prior to a subsequent purchase of a next item in the sequence of production of limited-edition items.

4. The method of claim 3, wherein the initial purchase is time-sensitive for completion.

5. The method of claim 4, wherein the method further includes incorporating a time clock to track a time between initiation and completion of the initial purchase.

6. The method of claim 5, wherein the time clock can cancel the initial purchase if not completed within a set timeframe.

7. The method of claim 1, wherein the sequence identification is generated by the computer system after selection and purchase of the limited-edition item.

8. The method of claim 7, wherein the method further includes the step of matching the sequence identification with the limited-edition item.

9. The method of claim 8, wherein the sequence identification is physically applied to the limited-edition item.

10. A system for generating and applying a ranked sequence identification to a limited-edition item, the system comprising:
a computer system having a user interface configured for selection of a limited-edition item;
a product selection and ordering process module configured to receive and process a purchase order for the limited-edition item, wherein the product selection and ordering process module generates a ranked sequence identification for the purchased item;
a production process module configured for associating the sequence identification with the purchased item and producing a transferable certificate of authenticity matched to the sequence identification.

11. The system of claim 10, wherein the product selection and ordering process module includes restricting a subsequent purchase of a limited-edition item in sequence until completion of a prior purchase of a limited-edition item.

12. The system of claim 10, wherein the product selection and ordering process module includes a control providing a timeframe for completion of the purchase order.

13. The system of claim 10 wherein the limited-edition item is a clothing item.

14. The system of claim 13 wherein the item is a limited-edition clothing article with a limited number of units produced.

15. The system of claim 1, wherein the sequence identification identified an ordered ranking of purchase of the limited-edition item.

16. The system of claim 10, wherein the certificate of authenticity includes the sequence identification corresponding to the limited-edition item.

17. The system of claim 10, wherein the sequence identification is a tag or marking affixed onto the item.

18. The system of claim 10, wherein the product selection and ordering process module further includes showing the ranked Sequence ID of an available item in a checkout system and notifying a potential purchaser of the ranked Sequence ID of the next item for purchase.
